(19) United States
(12) Patent Application Publication
(10) Pub. No.: US 2012/0275380 A1
(43) Pub. Date: Nov. 1, 2012

(54) Methods and Apparatus for Scheduling Paging Monitoring Intervals in TD-SCDMA Multimode Terminal

(75) Inventors: Tom Chin, San Diego, CA (US); Guangming Shi, San Diego, CA (US); Kuo-Chun Lee, San Diego, CA (US)

(73) Assignee: QUALCOMM INCORPORATED, San Diego, CA (US)

(21) Appl. No.: 13/501,715

(22) PCT Filed: Apr. 12, 2010
(86) PCT No.: PCT/US10/30768

§ 371 Date: Jul. 19, 2012

(30) Foreign Application Priority Data
Nov. 3, 2009 (US) 61257690

(51) Int. Cl. H04W 88/06

(52) U.S. Cl. 370/328

(57) ABSTRACT

Certain aspects of the present disclosure propose techniques for scheduling paging intervals in a multimode terminal (MMT) whenever a paging interval conflict between two different networks occurs. Certain aspects provide a method for communicating, by an MMT, with first and second networks via first and second radio access technologies (RATs), such as Time Division Synchronous Code Division Multiple Access (TD-SCDMA) and Code Division Multiple Access (CDMA) 1×RTT (Radio Transmission Technology), Evolution-Data Optimized (EVDO), or Wideband CDMA (WCDMA). The method generally includes determining that an overlap will occur between a first paging interval of the first network and a second paging interval of the second network, selecting between the first and second paging intervals based on at least one parameter associated with the first and second paging intervals, and detecting a message associated with paging based on the selected paging interval.

### CROSS-REFERENCE TO RELATED APPLICATION(S)

This application claims the benefit of U.S. Provisional Patent Application No. 61/257,690, entitled “METHODS AND APPARATUS FOR SCHEDULING PAGING MONITORING INTERVALS IN TD-SCDMA MULTIMODE TERMINAL,” filed on Nov. 3, 2009, which is expressly incorporated by reference herein in its entirety.

### BACKGROUND

1. Field

Certain aspects of the present disclosure generally relate to wireless communications and, more particularly, to scheduling paging intervals in a multimode terminal (MMT) capable of communicating via at least two different radio access technologies (RATs).

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but also to advance and enhance the user experience with mobile communications.

### SUMMARY

In an aspect of the disclosure a method for communicating, by a multimode terminal (MMT), with first and second networks via first and second radio access technologies (RATs) is provided. The method generally includes determining that an overlap will occur between a first paging interval of the first network and a second paging interval of the second network, selecting between the first and second paging intervals based on at least one parameter associated with the first and second paging intervals, and detecting a message associated with paging based on the selected paging interval.

In an aspect of the disclosure, an apparatus for communicating with first and second networks via first and second RATs is provided. The apparatus generally includes means for determining that an overlap will occur between a first paging interval of the first network and a second paging interval of the second network, means for selecting between the first and second paging intervals based on at least one parameter associated with the first and second paging intervals, and means for detecting a message associated with paging based on the selected paging interval.

In an aspect of the disclosure, an apparatus for communicating with first and second networks via first and second RATs is provided. The apparatus generally includes at least one processor and a memory coupled to the at least one processor. The at least one processor is typically configured to determine that an overlap will occur between a first paging interval of the first network and a second paging interval of the second network, to select between the first and second paging intervals based on at least one parameter associated with the first and second paging intervals, and to detect a message associated with paging based on the selected paging interval.

In an aspect of the disclosure, a computer-program product for communicating with first and second networks via first and second RATs is provided. The computer-program product typically includes a computer-readable medium having code for determining that an overlap will occur between a first paging interval of the first network and a second paging interval of the second network, selecting between the first and second paging intervals based on at least one parameter associated with the first and second paging intervals, and detecting a message associated with paging based on the selected paging interval.

### BRIEF DESCRIPTION OF THE DRAWINGS

Aspects and embodiments of the disclosure will become more apparent from the detailed description set forth below when taken in conjunction with the drawings in which like reference characters identify correspondingly throughout.

FIG. 1 is a block diagram conceptually illustrating an example of a telecommunications system in accordance with certain aspects of the present disclosure.

FIG. 2 is a block diagram conceptually illustrating an example of a frame structure in a telecommunications system in accordance with certain aspects of the present disclosure.

FIG. 3 is a block diagram conceptually illustrating an example of a Node B in communication with a user equipment device (UE) in a telecommunications system in accordance with certain aspects of the present disclosure.

FIG. 4 illustrates an example time division synchronous code division multiple access (TD-SCDMA) network overlaid on an example code division multiple access (CDMA) 1×RTT (Radio Transmission Technology) network in accordance with certain aspects of the present disclosure.

FIG. 5 illustrates an example paging interval conflict between a TD-SCDMA network and a CDMA 1× network in accordance with certain aspects of the present disclosure.

FIG. 6 is a functional block diagram conceptually illustrating example blocks executed to schedule paging interval monitoring of a multimode terminal (MMT) whenever there is a paging interval conflict between paging intervals of two different networks in accordance with certain aspects of the present disclosure.

FIG. 7 illustrates scheduling a paging interval during a paging interval conflict between two different networks based on whichever network's paging interval starts earlier or ends earlier, in accordance with certain aspects of the present disclosure.

FIG. 8 illustrates scheduling a paging interval during a paging interval conflict between two different networks based on whichever network's paging interval has a better signal quality, in accordance with certain aspects of the present disclosure.

FIG. 9 illustrates scheduling a paging interval during a paging interval conflict between two different networks based on whichever network's paging interval is part of a longer paging cycle duration or was not selected during a previous paging interval conflict, in accordance with certain aspects of the present disclosure.

FIG. 10 illustrates scheduling a paging interval during a paging interval conflict between two different networks based on whichever network's paging interval has a higher RAT-based priority, in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

### An Example Telecommunications System

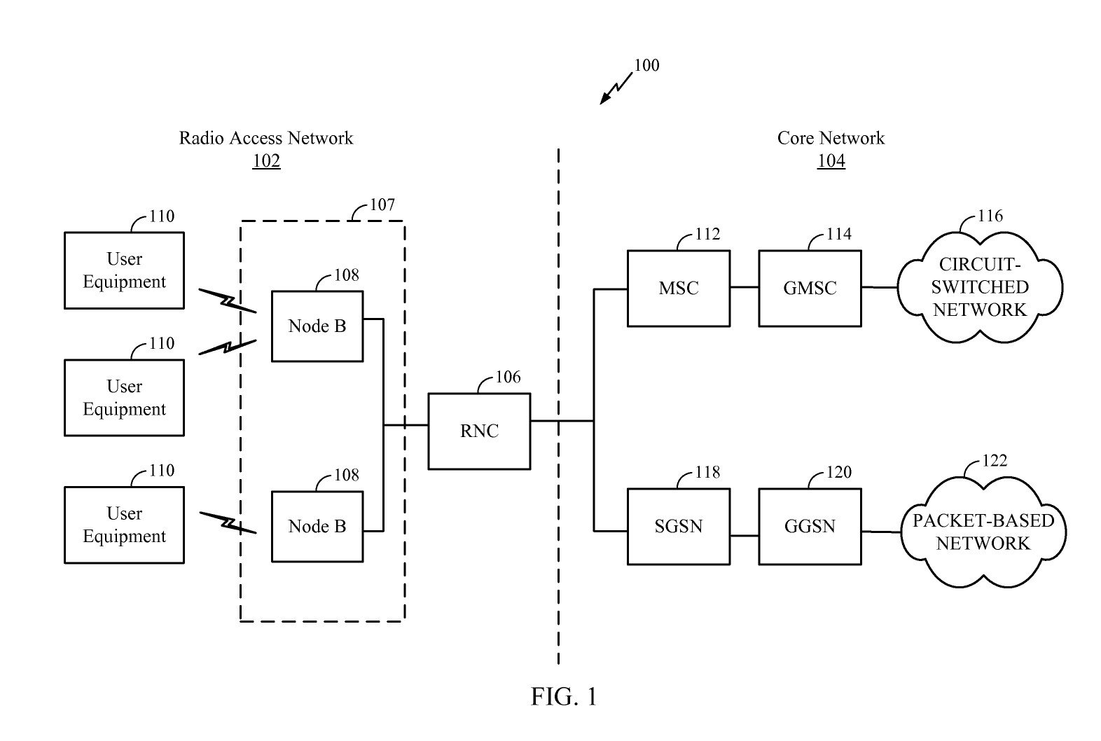

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a radio access network (RAN) 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

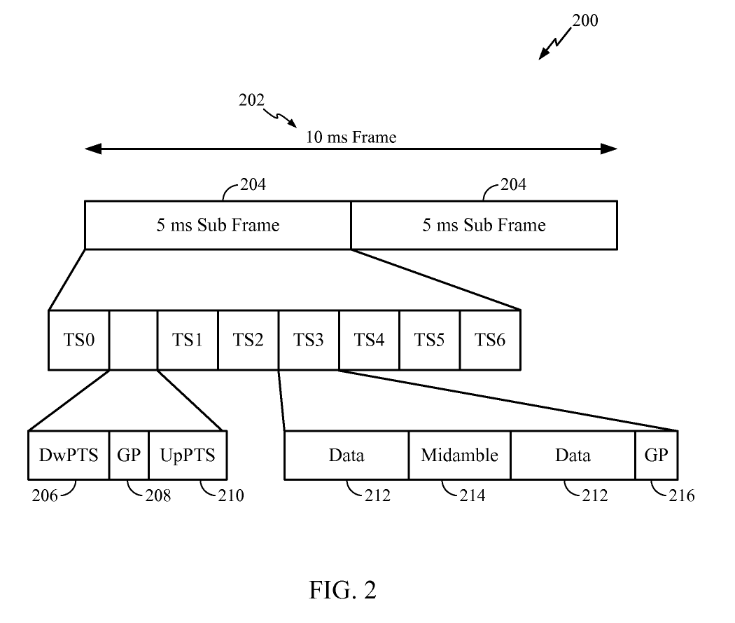

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

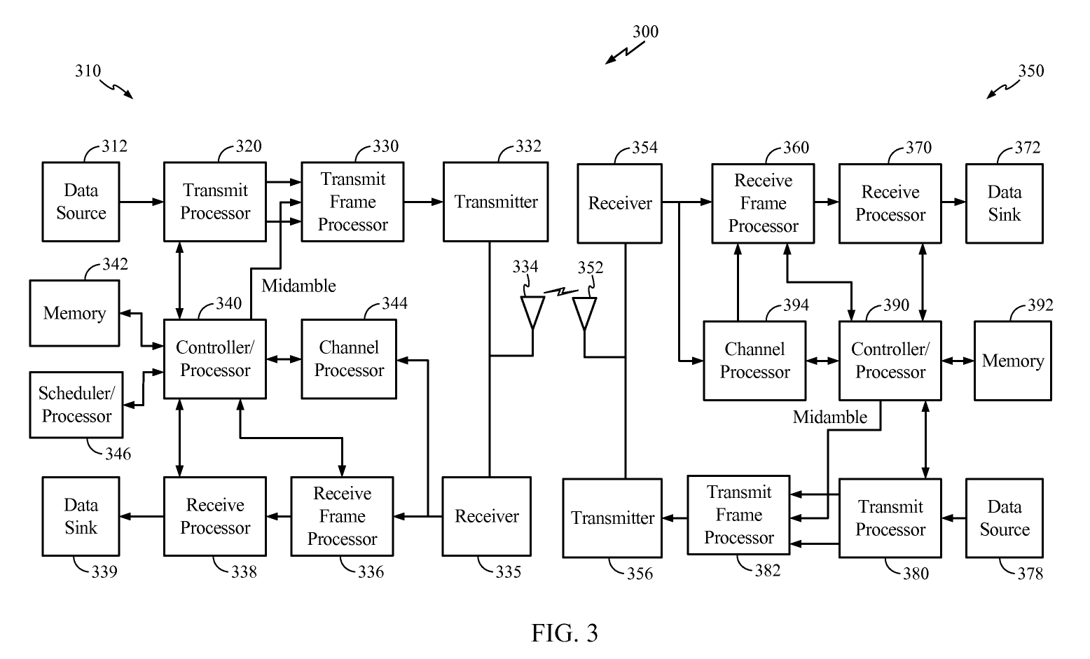

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

### An Example Method to Schedule Paging Monitoring Intervals in a TD-SCDMA Multimode Terminal

In order to expand the services available to subscribers, some UEs support communications with multiple radio access technologies (RATs). For example, a multimode terminal (MMT) may support TD-SCDMA and CDMA 1×RTT (Radio Transmission Technology) for voice and broadband data services.

As a result of supporting multiple RATs, there may be instances in which an MMT may be in an idle mode in both the TD-SCDMA and the CDMA 1×RTT networks. This may require the MMT to listen for traffic indication or paging messages in both networks. Unfortunately, an MMT with a single RF chain may only listen to one network at a time.

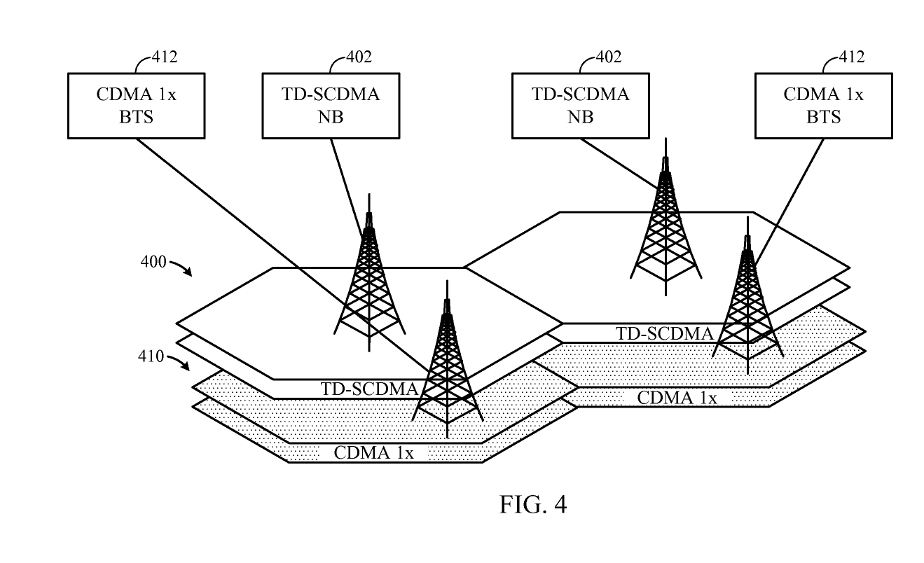

In deployment of the TD-SCDMA service, the TD-SCDMA network can become a radio access network overlaid with other technologies, such as CDMA 1×RTT (Radio Transmission Technology), Evolution-Data Optimized (EVDO), or Wideband CDMA (WCDMA). A multimode terminal (e.g., TD-SCDMA and CDMA 1×) may register with both networks to provide services. FIG. 4 illustrates an example TD-SCDMA network 400 overlaid on an example CDMA 1×RTT network 410. An MMT may communicate with either or both networks 400, 410 via TD-SCDMA node Bs (NBs) 402 and/or CDMA 1× base transceiver stations (BTSs) 412.

When the MMT—called user equipment (UE) in TD-SCDMA or a mobile station (MS) in CDMA—is in an idle state with both RATs, the terminal may periodically tune to the TD-SCDMA or CDMA 1× (or EVDO, WCDMA) base station to listen to the paging message.

The time interval to listen to paging messages (i.e., the paging interval) may be some duration over a periodic cycle:
TD-SCDMA: One Paging Indicator Channel (PICH) frame and two frames of Paging Channel (PCH), separated by at least N_{GAP} frames within a configurable Paging Block Periodicity over a configurable DRX (Discontinuous Reception) Cycle (2³, 2⁴, 2⁵, 2⁶, 2⁷, 2⁸, and 2⁹ frames).
CDMA 1×: 180 ms to cover Quick Paging Channel (QPCH) and Paging Channel (PCH) over a configurable Slotted Paging Cycle=1.28 seconds*2^{SLOT}^{_{—}}^{CYCLE}^{_{—}}^{INDEX}.
CDMA EVDO Rev 0: One control channel cycle=426.67 ms over a constant Paging Cycle=5.12 seconds.
CDMA EVDO Rev A: One control channel cycle=426.67 ms over a configured Paging Cycle=Period3/1.67 ms seconds.
WCDMA: 22 ms to cover Paging Indicator Channel (PICH) frame and one Paging Channel (PCH) frame over a configurable DRX (Discontinuous Reception) Cycle (2³, 2⁴, 2⁵, 2⁶, 2⁷, 2⁸, and 2⁹ frames).

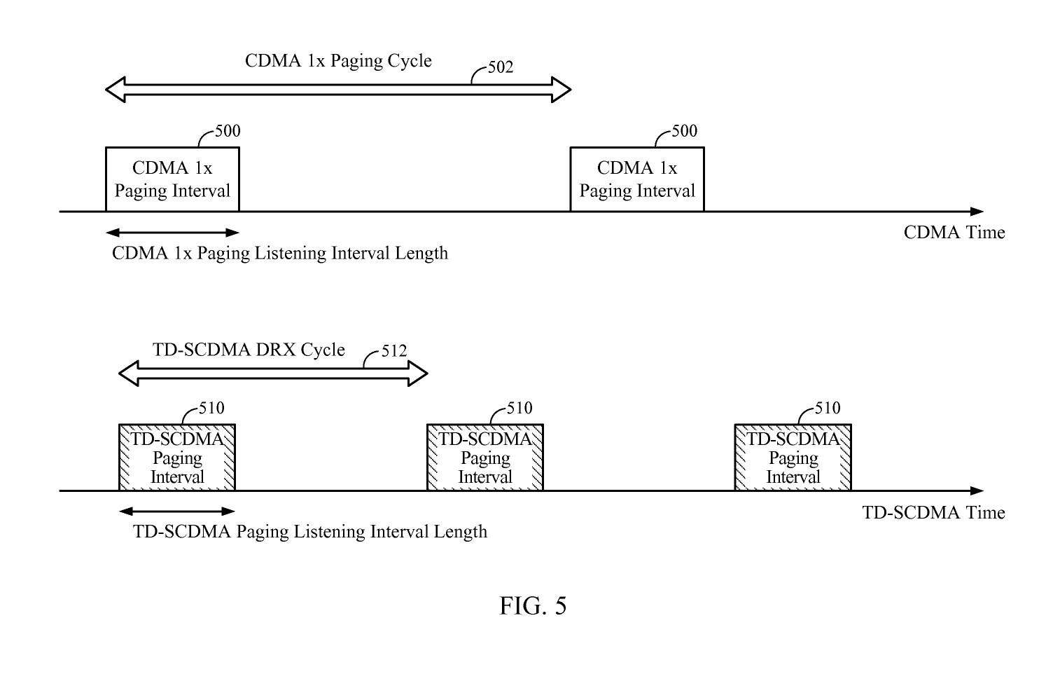

If the UE may only listen to one network at a time, when paging intervals for two networks such as TD-SCDMA and CDMA 1× (or EVDO, WCDMA) overlap, this leads to a paging interval conflict, and the terminal may only choose one network from which to listen to the paging messages. For example, FIG. 5 illustrates a paging interval conflict between a paging interval 500 of a CDMA 1× network and a paging interval 510 of a TD-SCDMA network. The paging interval conflict illustrated occurs during the first CDMA 1× paging cycle 502 and the first TD-SCDMA discontinuous receive (DRX) cycle 512 depicted.

Accordingly, what is needed are techniques and apparatus for selecting and scheduling paging intervals in an MMT whenever a paging interval conflict between two different networks occurs. Certain aspects of the present disclosure provide methods for an MMT, such as a TD-SCDMA multimode UE, to schedule paging intervals during paging interval conflicts.

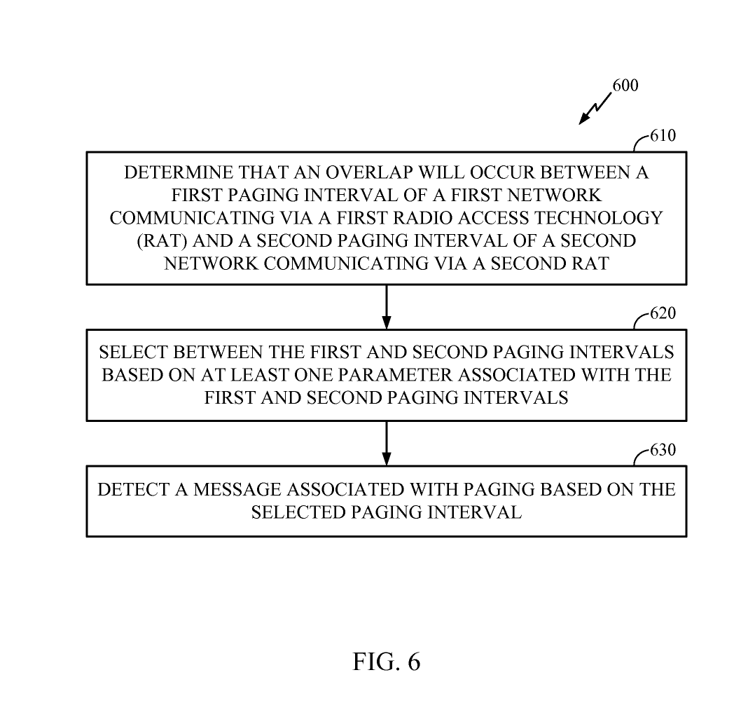

FIG. 6 is a functional block diagram conceptually illustrating example blocks 600 executed to schedule paging interval monitoring of a multimode terminal (MMT) communicating in two networks via two different RATs (e.g., TD-SCDMA and CDMA 1×) whenever there is a paging interval conflict between paging intervals of two different networks. Operations illustrated by the blocks 600 may be executed, for example, at the processor(s) 370 and/or 390 of the UE 350 from FIG. 3. The operations may begin at block 610 by determining that an overlap (e.g., a paging interval conflict) will occur between a first paging interval of a first network communicating via a first RAT and a second paging interval of a second network communicating via a second RAT. At block 620, the MMT may select between the first and second paging intervals based on at least one parameter associated with the first and second paging intervals. Examples of these parameters are provided below. At block 630, the MMT may detect a message associated with paging (e.g., a paging message) based on the selected paging interval from block 620.

If there is a paging interval conflict, aspects of the present disclosure may employ any of the following metrics as the parameter to decide which one of two paging intervals should be scheduled:
Whichever paging interval starts earlier will be the one to schedule.
Whichever paging interval ends earlier will be the one to schedule.
Whichever paging interval has better associated signal quality (e.g., receive power or signal-to-interference ratio) will be the one to schedule.
Whichever paging interval is part of the larger paging cycle will be the one to schedule.
Whichever paging interval was not selected and scheduled during the previous paging interval conflict will be the one to schedule.
The MMT may be configured to have a RAT-based priority. For example, the UE can be configured to always prefer and schedule TD-SCDMA paging intervals over CDMA 1× (or EVDO, WCDMA) paging intervals if there is a paging interval conflict.

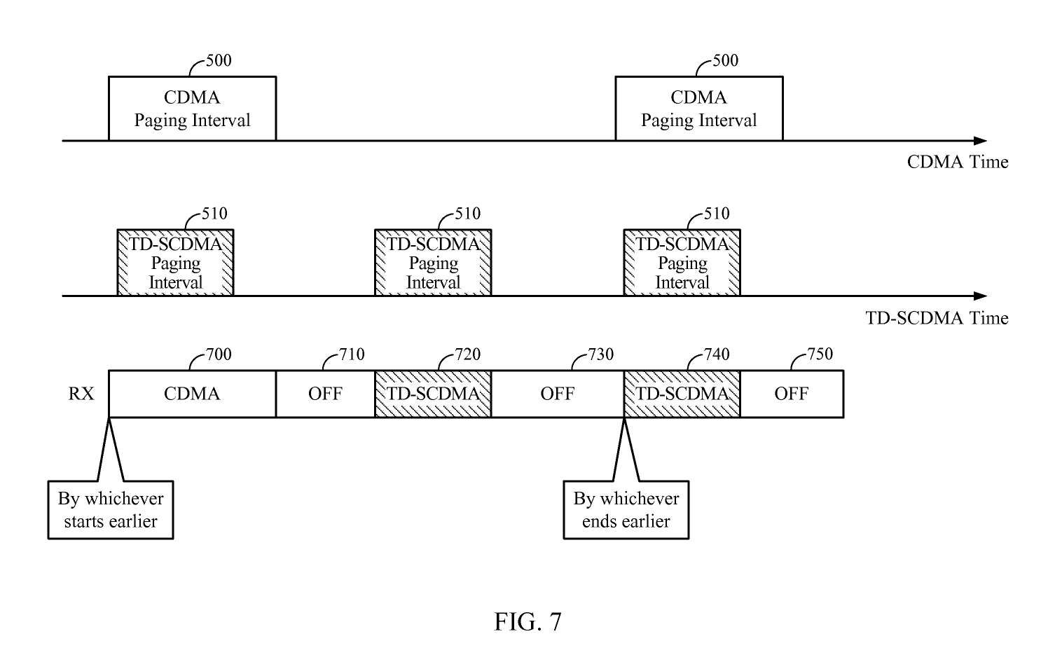

FIG. 7 illustrates scheduling a paging interval during a paging interval conflict between two different networks based on whichever network's paging interval starts earlier. For example, during the first paging interval conflict shown where the paging intervals 500, 510 overlap, the CDMA 1× paging interval 500 starts earlier than the TD-SCDMA paging interval 510. Therefore, the MMT has selected and scheduled the CDMA 1× paging interval at 700. For other aspects, the MMT may select the paging interval that starts later, rather than the one that starts earlier. At 710 and 730, there is no expected paging interval, so the receive chain (RX) may enter a standby mode during these times. At 720, the MMT may expect a TD-SCDMA paging interval 510 without a paging interval conflict, and therefore, the MMT may schedule the TD-SCDMA paging interval.

FIG. 7 also illustrates scheduling a paging interval during a paging interval conflict between two different networks based on whichever network's paging interval ends earlier. For example, during the second paging interval conflict shown where the paging intervals 500, 510 overlap, the TD-SCDMA paging interval 510 ends earlier than the CDMA 1× paging interval 500. Therefore, the MMT has selected and scheduled the TD-SCDMA paging interval at 740. For other aspects, the MMT may select the paging interval that ends later, rather than the one that ends earlier. At 750, there is no expected paging interval, so the receive chain may enter a standby mode during this time.

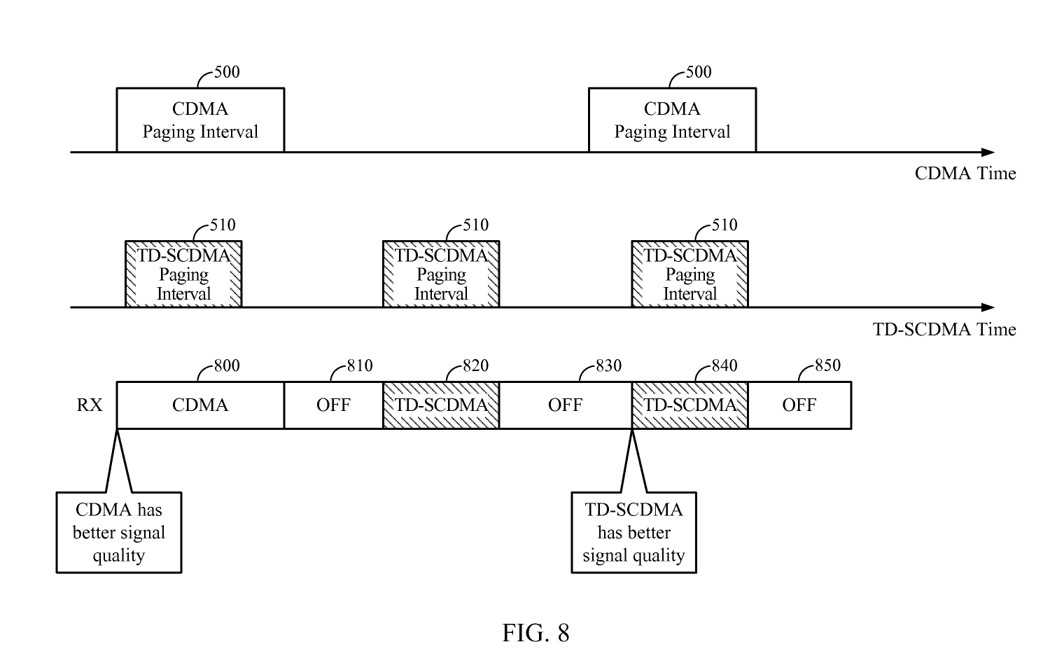

FIG. 8 illustrates scheduling a paging interval during a paging interval conflict between two different networks based on whichever network's paging interval has a better signal quality. For example, during the first paging interval conflict shown where the paging intervals 500, 510 overlap, the signal quality associated with the CDMA 1× paging interval has a better signal quality than the signal quality corresponding to the TD-SCDMA paging interval 510. Therefore, the MMT has selected and scheduled the CDMA 1× paging interval at 800. The signal quality may be determined based on a pilot signal associated with the current paging interval or on a pilot signal or paging message of a previous paging interval. The metric for signal quality may be a signal-to-interference ratio (SIR) or a received power, such as a received signal strength indication (RSSI).

At 810 and 830, there is no expected paging interval, so the receive chain (RX) may enter a standby mode during these times. At 820, the MMT may expect a TD-SCDMA paging interval 510 without a paging interval conflict. Therefore, the MMT may schedule the TD-SCDMA paging interval at 820.

During the second paging interval conflict shown in FIG. 8 where the paging intervals 500, 510 overlap, the signal quality associated with the TD-SCDMA paging interval 510 is greater than the signal quality corresponding to the CDMA 1× paging interval 500. Therefore, the MMT has selected and scheduled the TD-SCDMA paging interval at 840. At 850, there is no expected paging interval, so the receive chain may enter a standby mode during this time.

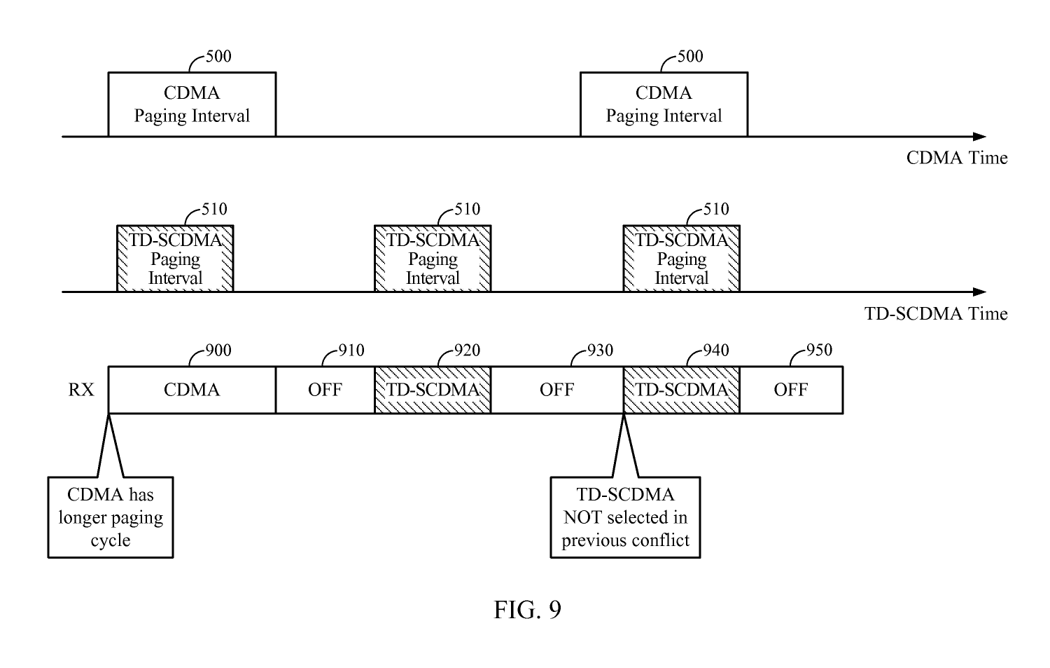

FIG. 9 illustrates scheduling a paging interval during a paging interval conflict between two different networks based on whichever network's paging interval is part of a longer paging cycle duration. For example, during the first paging interval conflict shown where the paging intervals 500, 510 overlap, CDMA 1× has a longer paging cycle than TD-SCDMA. Therefore, the MMT has selected and scheduled the CDMA 1× paging interval at 900. Because longer paging cycles generally mean that the paging messages may be received by the MMT less frequently, the MMT may prefer to schedule these paging intervals over paging intervals corresponding to shorter paging cycles. In other words, it may not be as important to monitor paging messages from RATs having shorter paging cycles because the next paging message will arrive shortly without a paging interval conflict. For other aspects, the MMT may select the paging interval that has a longer duration. At 910 and 930, there is no expected paging interval, so the receive chain (RX) may enter a standby mode during these times. At 920, the MMT may expect a TD-SCDMA paging interval 510 without a paging interval conflict, and therefore, the MMT may schedule the TD-SCDMA paging interval.

FIG. 9 also illustrates scheduling a paging interval during a paging interval conflict between two different networks based on whichever network's paging interval was not selected during a previous paging interval conflict. As described above for the first paging interval conflict depicted in FIG. 9, the CDMA 1× paging interval was scheduled. Therefore, during the second paging interval conflict shown, the MMT may select and schedule the TD-SCDMA paging interval at 940 since the CDMA 1× paging interval was selected during the previous paging interval conflict. In this manner, the MMT may give equal treatment to the paging intervals of different networks during paging interval conflicts, without preferring one over another. At 950, there is no expected paging interval, so the receive chain may enter a standby mode during this time.

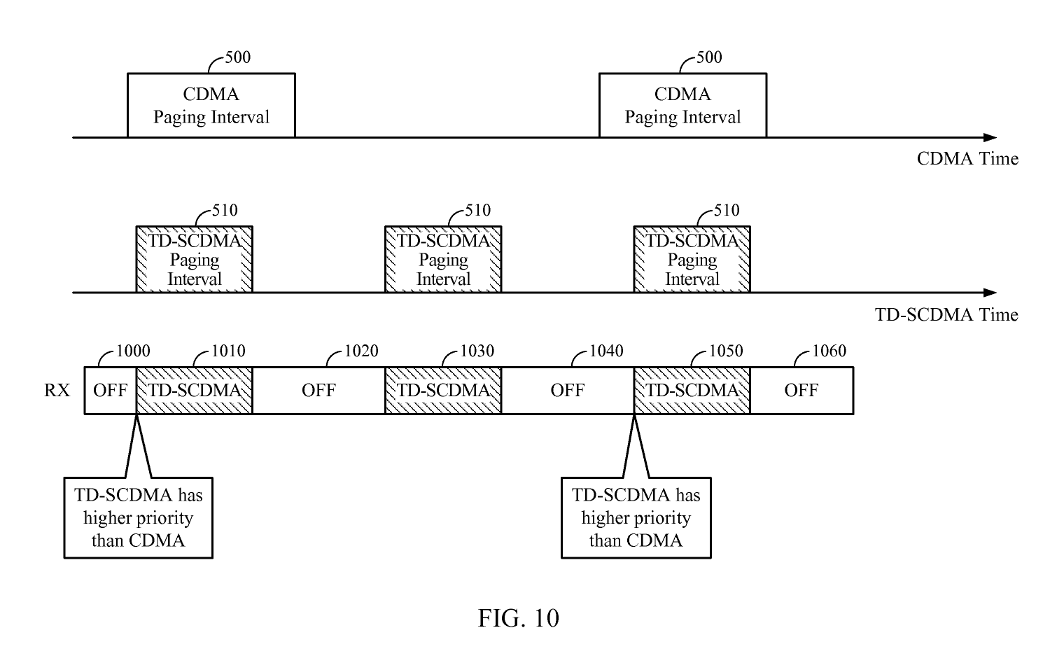

FIG. 10 illustrates scheduling a paging interval during a paging interval conflict between two different networks based on whichever network's paging interval has a higher RAT-based priority. For example, the MMT may be configured to prefer TD-SCDMA paging intervals over CDMA 1× paging intervals, or vice versa. This preference may be based on the regional market or calling area in which the MMT is sold. As shown in FIG. 10, during the first and second paging interval conflicts shown where the paging intervals 500, 510 overlap, the MMT may select and schedule the TD-SCDMA paging intervals at 1010 and 1050 based on this priority. At 1000, 1020, 1040, and 1060, there is no expected paging interval, so the receive chain (RX) may enter a standby mode during these times. At 1030, the MMT may expect a TD-SCDMA paging interval 510 without a paging interval conflict, and therefore, the MMT may schedule the TD-SCDMA paging interval.

In addition to the above criteria, aspects of the present disclosure also propose that the MMT can tune the RX chain to receive the other paging interval before or after the paging interval conflict's duration. For example, in cases where the MMT uses the earlier starting time as the parameter or metric, then when the first RAT's paging interval starting earlier ends, the MMT can tune to the second RAT's paging interval to monitor if any duration of this paging interval remains.

Aspects of the present disclosure may enhance a TD-SCDMA multimode UE to monitor paging channels in a second RAT, such as CDMA 1×, EVDO, and WCDMA. For example, a TD-SCDMA multimode UE may choose one of two conflicting paging intervals to listen for paging messages while achieving some fairness or performance gain.

In one configuration, the apparatus 350 for wireless communication includes means for determining an overlap will occur between a first paging interval of a first network communicating via a first RAT and a second paging interval of a second network communicating via a second RAT, means for selecting between the first and second paging intervals based on at least one parameter associated with the first and second paging intervals, and means for detecting a message associated with paging based on the selected paging interval. In one aspect, the aforementioned means may be the processor(s) 370 and/or 390 configured to perform the functions recited by the aforementioned means. In another aspect, the aforementioned means may be a module or any apparatus configured to perform the functions recited by the aforementioned means.

Several aspects of a telecommunications system have been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read-only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for communicating, by a multi-mode terminal (MMT), with first and second networks via first and second radio access technologies (RATs), comprising:
determining that an overlap will occur between a first paging interval of the first network and a second paging interval of the second network;
selecting between the first and second paging intervals based on at least one parameter associated with the first and second paging intervals; and
detecting a message associated with paging based on the selected paging interval.

2. The method of claim 1, wherein one of the first and second RATs comprises time division synchronous code division multiple access (TD-SCDMA).

3. The method of claim 2, wherein the other of the first and second RATs comprises code division multiple access (CDMA) 1×RTT (Radio Transmission Technology), Evolution-Data Optimized (EVDO), or Wideband CDMA (WCDMA).

4. The method of claim 1, wherein the at least one parameter comprises a starting time of the first and second paging intervals such that the selected paging interval is the first or the second paging interval with the earlier starting time.

5. The method of claim 1, wherein the at least one parameter comprises an ending time of the first and second paging intervals such that the selected paging interval is the first or the second paging interval with the earlier ending time.

6. The method of claim 1, wherein the at least one parameter comprises a signal quality of the first and second paging intervals such that the selected paging interval is the first or the second paging interval with the better signal quality.

7. The method of claim 6, wherein the signal quality of the first and second paging intervals comprises a signal-to-interference ratio (SIR) or a received signal strength indication (RSSI) determined from a pilot signal associated with one of the first and second paging intervals.

8. The method of claim 1, wherein the at least one parameter comprises a duration of the first and second paging intervals such that the selected paging interval is the first or the second paging interval with the longer duration.

9. The method of claim 1, wherein the at least one parameter comprises a duration of a paging cycle, each paging cycle containing one of the first and second paging intervals, such that the selected paging interval is the first or the second paging interval in the paging cycle with the longer duration.

10. The method of claim 1, wherein the at least one parameter comprises a selected network of a previously selected paging interval such that the selected paging interval is the first or the second paging interval of either the first network or the second network, respectively, that is different from the previously selected paging interval's network.

11. The method of claim 1, wherein the at least one parameter comprises a RAT-based priority of the first and second paging intervals such that the selected paging interval is the first or the second paging interval with the higher RAT-based priority.

12. The method of claim 11, wherein the MMT is configured with the RAT-based priority.

13. The method of claim 1, further comprising detecting a message associated with paging from the first network when the first paging interval of the first network does not overlap with the second paging interval.

14. An apparatus for communicating with first and second networks via first and second radio access technologies (RATs), comprising:
means for determining that an overlap will occur between a first paging interval of the first network and a second paging interval of the second network;
means for selecting between the first and second paging intervals based on at least one parameter associated with the first and second paging intervals; and
means for detecting a message associated with paging based on the selected paging interval.

15. The apparatus of claim 14, wherein one of the first and second RATs comprises time division synchronous code division multiple access (TD-SCDMA).

16. The apparatus of claim 15, wherein the other of the first and second RATs comprises code division multiple access (CDMA) 1×RTT (Radio Transmission Technology), Evolution-Data Optimized (EVDO), or Wideband CDMA (WCDMA).

17. The apparatus of claim 14, wherein the at least one parameter comprises a starting time of the first and second paging intervals such that the selected paging interval is the first or the second paging interval with the earlier starting time.

18. The apparatus of claim 14, wherein the at least one parameter comprises an ending time of the first and second paging intervals such that the selected paging interval is the first or the second paging interval with the earlier ending time.

19. The apparatus of claim 14, wherein the at least one parameter comprises a signal quality of the first and second paging intervals such that the selected paging interval is the first or the second paging interval with the better signal quality.

20. The apparatus of claim 19, wherein the signal quality of the first and second paging intervals comprises a signal-to-interference ratio (SIR) or a received signal strength indication (RSSI) determined from a pilot signal associated with one of the first and second paging intervals.

21. The apparatus of claim 14, wherein the at least one parameter comprises a duration of the first and second paging intervals such that the selected paging interval is the first or the second paging interval with the longer duration.

22. The apparatus of claim 14, wherein the at least one parameter comprises a duration of a paging cycle, each paging cycle containing one of the first and second paging intervals, such that the selected paging interval is the first or the second paging interval in the paging cycle with the longer duration.

23. The apparatus of claim 14, wherein the at least one parameter comprises a selected network of a previously selected paging interval such that the selected paging interval is the first or the second paging interval of either the first network or the second network, respectively, that is different from the previously selected paging interval's network.

24. The apparatus of claim 14, wherein the at least one parameter comprises a RAT-based priority of the first and second paging intervals such that the selected paging interval is the first or the second paging interval with the higher RAT-based priority.

25. The apparatus of claim 24, wherein the apparatus is configured with the RAT-based priority.

26. The apparatus of claim 14, further comprising means for detecting a message associated with paging from the first network when the first paging interval does not overlap with the second paging interval.

27. An apparatus for communicating with first and second networks via first and second radio access technologies (RATs), comprising:
at least one processor configured to:
determine that an overlap will occur between a first paging interval of the first network and a second paging interval of the second network;
select between the first and second paging intervals based on at least one parameter associated with the first and second paging intervals; and
detect a message associated with paging based on the selected paging interval; and
a memory coupled to the at least one processor.

28. The apparatus of claim 27, wherein one of the first and second RATs comprises time division synchronous code division multiple access (TD-SCDMA).

29. The apparatus of claim 28, wherein the other of the first and second RATs comprises code division multiple access (CDMA) 1×RTT (Radio Transmission Technology), Evolution-Data Optimized (EVDO), or Wideband CDMA (WCDMA).

30. The apparatus of claim 27, wherein the at least one parameter comprises a starting time of the first and second paging intervals such that the selected paging interval is the first or the second paging interval with the earlier starting time.

31. The apparatus of claim 27, wherein the at least one parameter comprises an ending time of the first and second paging intervals such that the selected paging interval is the first or the second paging interval with the earlier ending time.

32. The apparatus of claim 27, wherein the at least one parameter comprises a signal quality of the first and second paging intervals such that the selected paging interval is the first or the second paging interval with the better signal quality.

33. The apparatus of claim 32, wherein the signal quality of the first and second paging intervals comprises a signal-to-interference ratio (SIR) or a received signal strength indication (RSSI) determined from a pilot signal associated with one of the first and second paging intervals.

34. The apparatus of claim 27, wherein the at least one parameter comprises a duration of the first and second paging intervals such that the selected paging interval is the first or the second paging interval with the longer duration.

35. The apparatus of claim 27, wherein the at least one parameter comprises a duration of a paging cycle, each paging cycle containing one of the first and second paging intervals, such that the selected paging interval is the first or the second paging interval in the paging cycle with the longer duration.

36. The apparatus of claim 27, wherein the at least one parameter comprises a selected network of a previously selected paging interval such that the selected paging interval is the first or the second paging interval of either the first network or the second network, respectively, that is different from the previously selected paging interval's network.

37. The apparatus of claim 27, wherein the at least one parameter comprises a RAT-based priority of the first and second paging intervals such that the selected paging interval is the first or the second paging interval with the higher RAT-based priority.

38. The apparatus of claim 37, wherein the apparatus is configured with the RAT-based priority.

39. The apparatus of claim 27, wherein the at least one processor is configured to detect a message associated with paging from the first network when the first paging interval of the first network does not overlap with the second paging interval.

40. A computer-program product for communicating with first and second networks via first and second radio access technologies (RATs), the computer-program product comprising:
a computer-readable medium comprising code for:
determining that an overlap will occur between a first paging interval of the first network and a second paging interval of the second network;
selecting between the first and second paging intervals based on at least one parameter associated with the first and second paging intervals; and
detecting a message associated with paging based on the selected paging interval.

41. The computer-program product of claim 40, wherein one of the first and second RATs comprises time division synchronous code division multiple access (TD-SCDMA).

42. The computer-program product of claim 41, wherein the other of the first and second RATs comprises code division multiple access (CDMA) 1×RTT (Radio Transmission Technology), Evolution-Data Optimized (EVDO), or Wideband CDMA (WCDMA).

43. The computer-program product of claim 40, wherein the at least one parameter comprises a starting time of the first and second paging intervals such that the selected paging interval is the first or the second paging interval with the earlier starting time.

44. The computer-program product of claim 40, wherein the at least one parameter comprises an ending time of the first and second paging intervals such that the selected paging interval is the first or the second paging interval with the earlier ending time.

45. The computer-program product of claim 40, wherein the at least one parameter comprises a signal quality of the first and second paging intervals such that the selected paging interval is the first or the second paging interval with the better signal quality.

46. The computer-program product of claim 45, wherein the signal quality of the first and second paging intervals comprises a signal-to-interference ratio (SIR) or a received signal strength indication (RSSI) determined from a pilot signal associated with one of the first and second paging intervals.

47. The computer-program product of claim 40, wherein the at least one parameter comprises a duration of the first and second paging intervals such that the selected paging interval is the first or the second paging interval with the longer duration.

48. The computer-program product of claim 40, wherein the at least one parameter comprises a duration of a paging cycle, each paging cycle containing one of the first and second paging intervals, such that the selected paging interval is the first or the second paging interval in the paging cycle with the longer duration.

49. The computer-program product of claim 40, wherein the at least one parameter comprises a selected network of a previously selected paging interval such that the selected paging interval is the first or the second paging interval of either the first network or the second network, respectively, that is different from the previously selected paging interval's network.

50. The computer-program product of claim 40, wherein the at least one parameter comprises a RAT-based priority of the first and second paging intervals such that the selected paging interval is the first or the second paging interval with the higher RAT-based priority.

51. The computer-program product of claim 50, wherein the computer-readable medium comprises code with the RAT-based priority.

52. The computer-program product of claim 40, wherein the computer-readable medium comprises code for detecting a message associated with paging from the first network when the first paging interval does not overlap with the second paging interval.
